(19) United States
(12) Patent Application Publication
(10) Pub. No.: US 2016/0066501 A1
(43) Pub. Date: Mar. 10, 2016

(54) POTATO HARVESTER CHAIN CONVEYOR WITH SLEEVES

(71) Applicants: Wayde ALTENDORF, Hickson, ND (US); Dale M. COLLETTE, Grafton, ND (US)

(72) Inventors: Wayde ALTENDORF, Hickson, ND (US); Dale M. COLLETTE, Grafton, ND (US)

(21) Appl. No.: 14/844,908

(22) Filed: Sep. 3, 2015

Related U.S. Application Data
(60) Provisional application No. 62/045,991, filed on Sep. 4, 2014.

(51) Int. Cl. A01D 17/10

(52) U.S. Cl. CPC A01D 17/10; A01D 2017/103

(57) ABSTRACT

A potato harvester chain conveyor has a plurality of rods spanning between support portions providing spacing to retain potatoes by allow soil to drop through. The spacing may be field modified by adding resilient split sleeves on the rods. The invention includes the sleeves, method of attachment, methods of removal, and the sleeves in combination with the conveyor and/or the harvester with the conveyor.

### CROSS-REFERENCE TO RELATED APPLICATIONS

The present application claims the benefit of U.S. Provisional Patent Application No. 62/045,991, filed Sep. 4, 2014, which is hereby incorporated by reference herein in its entirety.

### FIELD OF THE INVENTION

This invention relates to crop harvesting equipment, more particularly to potato harvesters with conveyors.

### BACKGROUND OF THE INVENTION

Potato harvesters lift and sift mounds of soil that contain the potatoes. The basic sifting, the separation of the potatoes from the soil, is accomplished by conveying the potatoes and soil on a continuous chain conveyor formed of spaced crossing portions which are configured as steel cross rods. The optimal spacing between cross rods can vary depending on a number of factors such as the soil makeup, the average and range of potato sizes, and the moisture in the soil. It may often be the case that the ideal bar spacing in the early morning harvest is not the ideal bar spacing in the afternoon harvest due to changing conditions, for example, the soil drying. In conventional potato harvesters, in order to change the spacing, the entire chain needs to be traded out. This can be tedious and difficult. It would be advantageous to have an easier and more economical way of changing spacing.

### SUMMARY OF THE INVENTION

A potato conveying chain has cross bars spanning between webbing belts or steel linkages. Removable sleeves attach to the cross bars providing a reduced spacing between the cross bars. The removable sleeves, in embodiments, may be formed of polymers and be a C-shape in cross section such that they may be opened and press fit on each of the cross bars. In embodiments, each sleeve may be formed of more than one part, for example two clam shell halves that are affixed together around the bar. The halves may have integral fasteners or may use circular clamps or the like for securement to the rods. In embodiments, the sleeves by have a tight, snug fit on the respective bars and in other embodiments, the sleeves may have a loose fit. In embodiments, each consecutive pair of rods may have different size sleeves allowing three different spacings between adjacent rods, by the removal of one, or the other, or both sleeves.

In embodiments of the invention, a potato harvester chain with crossing portions has the spacing between crossing portions changed without changing out the chain. Sleeves are positioned on or removed from individual cross rods thereby changing the diameter or width of the crossing portions and accordingly the spacing between sequential pairs of crossing portions. In embodiments, the changeout of the sleeves may be performed on every other crossing portion.

A feature and advantage of embodiments of the invention is that a changeout of the spacing between crossing portions of a continuous potato harvesting chain may occur in the field. That is without taking the harvester to the shop for the changeout.

In embodiments of the invention, a method of manufacturing a sleeve for a potato harvester chain comprises extruding a polymer and cutting the extrusion to desired lengths, additional operations may be performed before or during the cutting to desired lengths such as adding notches or recesses for facilitating removal of the sleeves from cross bars when installed. The extrusion die may include circumferential space ribbing to from internal axial ribbing in the sleeve. In conventional conveying chains, the steel cross rods have a central straight portion and curved rod portions on opposite ends of the central straight portion. The method further comprising cutting the length of the extrusion to correspond to the length of the straight portion. The length may be cut so that the curved rod portion engages a feature, such as a gap or a recess, of the sleeve inhibiting rotation of the sleeve on the rod. The method may further comprise, at or before the cutting adding a notch or recess for engaging the curved rod portion. The methods comprise utilizing extrusion dies corresponding to the features described herein and extruding extrusions with the features described herein.

In embodiments of the invention, sleeves for cross rods of a potato harvester chain has a cross sectional shape of a “C” with the gap of the C sized to be less that the diameter of the steel rod crossing portion upon which it is to be placed. In such embodiments, the sleeve may be attached by laying the sleeve over the cross rod, with the gap engaging the rod, and striking the sleeve opposite the rod to force the sleeve over the rod. Tools such as a channel lock or pliers may be used to squeeze the sleeve onto the rod. The sleeve may be removed by initially lifting or prying one end of the attached sleeve from the steel cross bars and progressively peeling the sleeve off of the rod. Tools such as a pry bar may be utilized for initial lifting and continued peeling. In embodiments, the internal diameter of the C is slightly smaller, in the non-applied state, that the diameter of the steel rod of the crossing portion, thereby providing a snug and very stable attachment.

In other embodiments, the internal diameter of the sleeve, in the non-applied state may be slightly greater than the diameter of the rod, thereby allowing a loose fit on the rod. Methods of attachment and removal may be the same as or similar to that described above.

In embodiments of the invention, sleeves for cross rods of a potato harvester chain has a cross sectional shape of a “O” with a radially and axially extending slit such that the sleeve may be opened and placed on each of or alternate ones of the steel cross rods. The internal diameter of the sleeve may be sized to be less that the diameter of the steel rod crossing portion upon which it is to be placed. In embodiments, the internal diameter of the O is slightly smaller, in the non-applied state, that the diameter of the steel rod of the crossing portion, thereby providing a snug and very stable attachment. In such embodiments, the sleeve may be removed by lifting or prying one end of the attached sleeve and opening the O at the slit and peeling the sleeves from the steel cross rods. In embodiments the internal diameter may be slightly larger than the diameter of the cross rods where by the sleeves may slightly move in a radial direction and rotate on the bars.

In embodiments, alternate rods on the potato conveyer may receive the sleeves whereby the spacing between each two crossing portions is measured between a rod and a sleeve on the adjacent rod. In embodiments, the invention includes methods of changing the spacing between adjacent crossing portions by adding or removing sleeves from every other consecutive crossing rod.

In embodiments, the sleeves may enhance the carrying capability of the potato conveyer by having, for example, alternate rods with sleeves and then the rods with sleeves will extend farther in a direction perpendicular to the path-of-travel of the conveyor thereby inhibiting roll back of the potatoes and enhance the lifting capability of the conveyor.

A feature and advantage of embodiments of the invention is that use of sleeves formed of polymers, such as polyethylene, may provide enhanced protection from bruising from the crossing portions of the conveyor.

A feature and advantage of embodiments of the invention is that spacing between adjacent crossing portions may be easily changed without changing out the entire chain; rather, sleeves may be added or removed to alter the spacing.

A feature and advantage of embodiments of the invention is that each sleeve may be formed of a single piece of polymer and readily attached and removed utilizing hand tools.

A feature and advantage of embodiments of the invention is that they may be easily manufactured by extruding polymer components.

A feature and advantage of embodiments of the invention is that sleeves formed of polymer extrusions may have axially extending internal structures that are compressible or that cause rotation of the sleeve upon impact with potatoes thereby absorbing shock and minimizing bruising of the potatoes. In embodiments, the sleeve may have a composite construction with a rigid exterior and less rigid interior the engages the steel rod

A feature and advantage of embodiments of the invention is a sleeve that is C-shaped with an open side that snaps around a cross rod, and where the cross rod has an angled portion that is positioned at the open side to partially fit in the open side to inhibit rotation of the sleeve.

A feature and advantage of embodiments of the invention is that each sleeve may be formed of a single piece of polymer and be attached and secured to a rod without fasteners or additional components to secure the sleeve to the rod. In other embodiments, fasteners may be utilized, the fasteners may or may not be unitary with the sleeve or sleeve portions.

A feature and advantage of embodiments of the invention is that rotation prevention structure may be provided on the sleeve, such may be a recess, slit, notch, that engages a curved rod portion or portions of the cross rod that are located on each side of the straight portion of the cross rods. In embodiments of the invention the wall thickness of the sleeve is uniform, in other embodiments, a select portion may be thicker to effectively narrow the gap between rods without raising the height of the gap as much, or the opposite, minimizing the gap reduction while increasing the effective height of the rod/sleeve combination. In cross-section the sleeve may have an oblong shape.

A feature and advantage of embodiments of the invention is that the aspects of chain conveyor inventions illustrated herein may be used for chain conveyors in locations on potato harvesters other than what is shown.

### DESCRIPTION OF THE FIGURES

FIG. 1A is a schematic elevational view of a prior art potato harvester illustrating the placement of a chain conveyor according to embodiments of the invention.

FIG. 1B is a schematic view of a prior art potato harvester chain conveyor.

FIG. 1C illustrate spacing options as originally provided by the cross rods and as available with the sleeves according to embodiments of the invention.

FIG. 2 is perspective partial sectional view of a portion of a potato harvester conveyor chain according to embodiments of the invention with sleeves positioned on each straight portion of cross rods of the conveyor.

FIG. 3 is a perspective view of a prior art individual cross bar with integral linkages for connecting to like cross bars for forming a conveyor chain.

FIG. 4 is a perspective view of a prior art individual bar with two straight portions riveted to a webbing defining three cross portion support portions.

FIG. 5 is a perspective view of a sleeve according to embodiments of the invention.

FIG. 6 is a perspective view on an end of a sleeve according to embodiments of the invention with a C-shape cross section and internal ribbing.

FIG. 7 is a perspective view on an end of a sleeve according to embodiments of the invention with an O-shaped sleeve and an axially extending slit.

FIG. 8 is a perspective view on an end of a sleeve according to embodiments of the invention having a pair of clam shell halves joinable by latch portions.

FIG. 9 is a perspective view on an end of a sleeve according to embodiments of the invention having a living hinge and a latch portion.

### DETAILED DESCRIPTION

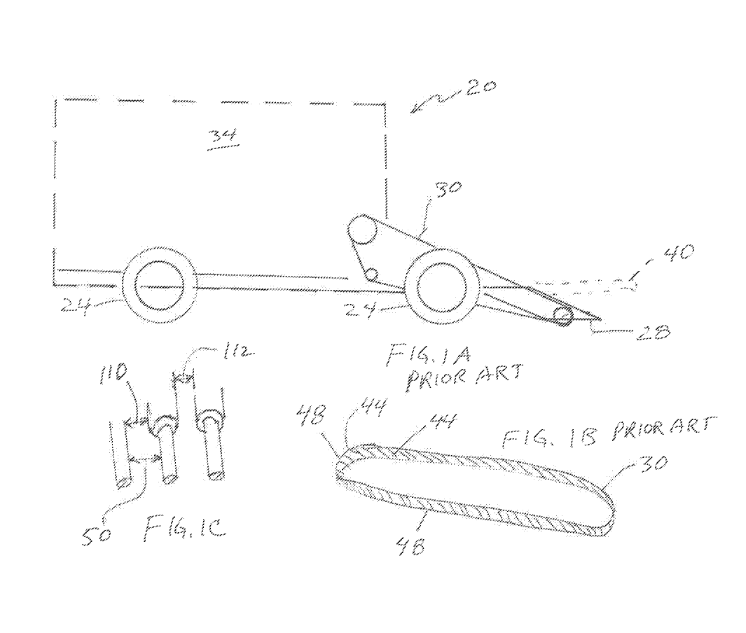

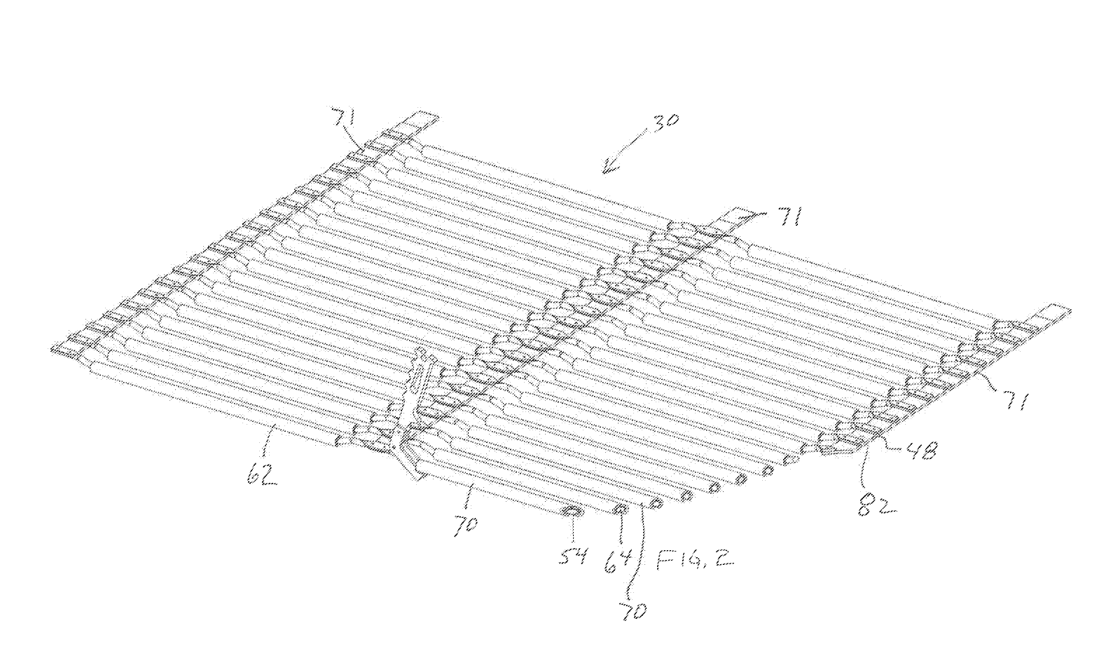

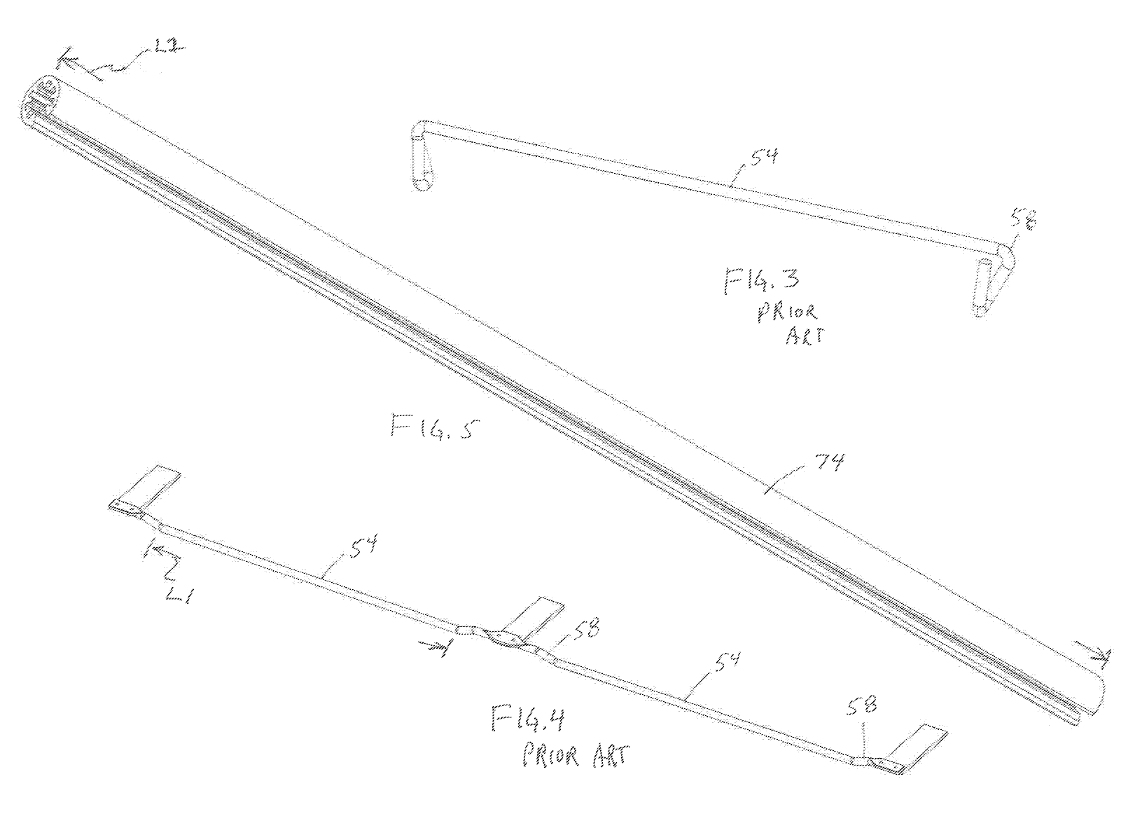

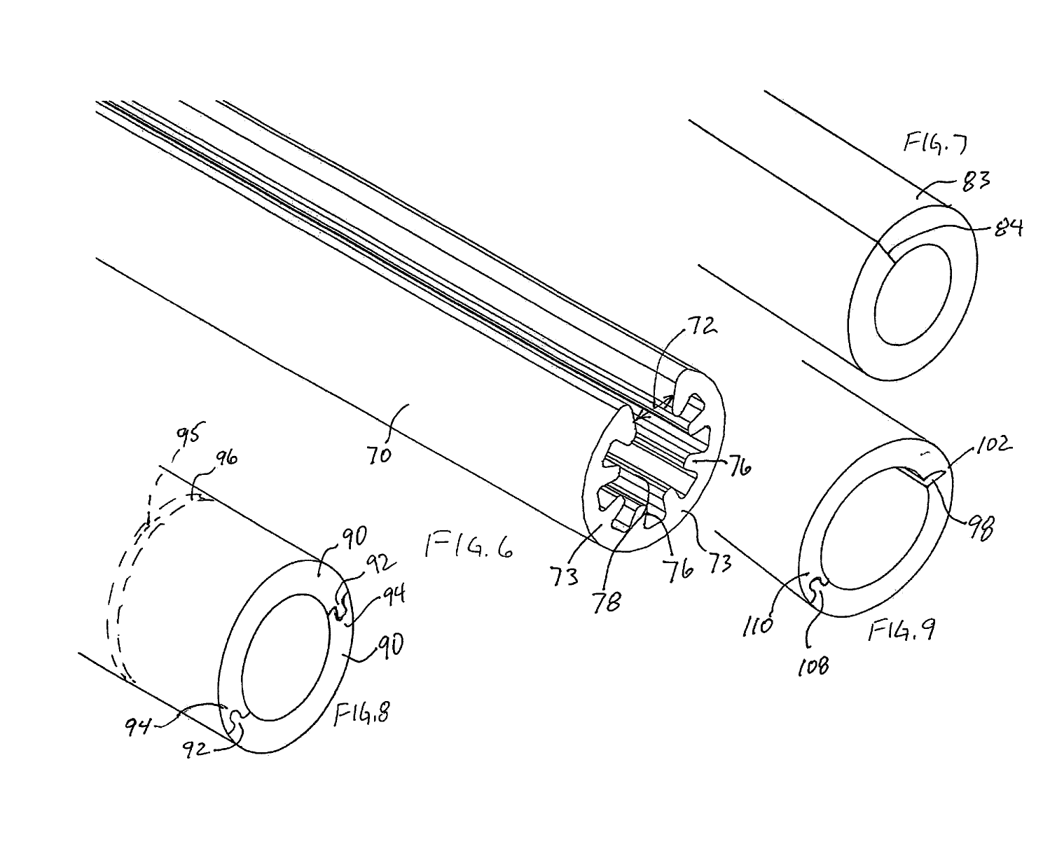

Referring FIG. 1A a prior art potato harvester 20 is illustrated and generally comprises is a frame 22, wheels 24, a forward digging portion 28, an endless chain conveyor 30 extending from or associated with the digging portion, and associated processing and/or conveying portions 34. The harvester may be pulled by a tractor hitched to the trailer hitch 40 or may be self-propelled. Referring to FIGS. 1B, 1C, 3, and 4, prior art chain conveyors and portions are illustrated that are amendable to receiving the sleeves according to embodiments of the inventions herein. The conveyors comprise a multiplicity of individual crossing portions 44, configured as steel rods, and crossing support portions 48 that secure the crossing portions in a parallel arrangement with a desired spacing 50. The crossing portions may each have straight portions 54 with curved portions 58 on each end of the straight portion. The crossing portion support portions 48 may be configured as straps or steel linkages. The steel linkages may be formed by end portions of the crossing rods as illustrated in FIG. 3.

Various configurations of potato harvesters are known and many have the above basic configurations and provide exemplary operation, components, and the “associated processing and/or conveying portions; see: U.S. Pat. Nos. 7,958,942; 4,971,155; 4,787,461; 4,176,750; 3,455,447; 3,200,888; 2,828,825; 2,633,685; 2,107,021; and 1,750,362. All of which are incorporated by reference herein.

Referring to FIG. 2, a portion of a potato harvester conveyor chain 30 according to embodiments of the invention, has parallel crossing portions 62 configured as steel rods 64 with sleeves 70 and webbing 71 supporting the steel rods. Each steel rod having a pair of straight portions 54, and an elongate sleeve 70 on each straight portion. The straight portions having a length L1 and the sleeves 70 having a length L2 configured to correspond to the length L1 of the straight portions. Configurations of the sleeves secured to the crossing rods may be as illustrated in FIGS. 5 and 6, with a generally C-shape in the cross section, defining a gap 72, a body 73, a smooth generally cylindrical exterior surface 74, a plurality of axially extending interior ribs 76, and an open interior 78. The crossing portion support portion 71, shown as webbing or straps, may be attached to the crossing rods with rivets 82.

FIG. 7 is a perspective view on an end of an alternative configuration of a sleeve 83 with an O shape in the cross section and a slit 84 allowing the sleeve to be opened for attachment to a steel rod. The resiliency in the polymer utilized, for example polyethylene, according to embodiments of the invention allow sleeves to be opened and then return to their original shape. FIG. 8 illustrates an embodiment where a clam shell half 90 with two cooperating latching portions 92, 94 on each half whereby two identical pieces may be assembled together around a sleeve. In instances, supplemental circumferential attachment fasteners, such as plastic tie strips 95, may be utilized in a groove 96 to supplementally secure the two clam shell halves together.

FIG. 9 illustrates a configuration that may be extruded with an interior axially notch 98 such that the polymer adjacent thereto defines a living hinge 102 to facilitate opening and closing of the sleeve. Cooperating latching portions 108, 110 allow the sleeve to be snapped or latched shut. The various latching, fastening, connecting means described above, of course may be used in various combinations as appropriate.

In embodiments, the sleeves may be formed of extruded polymers. In some cases other materials may be used such as metals, particularly softer metals, for example aluminum, which may be secured by way of cooperating clam shell halves secured by metal fasteners. There also may be other materials, rubber or natural material, available without departing from the spirit and scope of the inventive aspects discussed and disclosed herein.

Referring to FIG. 1C, the conventional spacing 50 may be modified by a sleeve 70 on every other bar providing the spacing 110 between each consecutive pair of cross rods, or by putting the sleeves on all of the rods providing the spacing 112. Where all of the rods have sleeves thereon, the spacing may be increased in two different ways with two different spacings available; by taking off every other sleeve, or by taking off all of the sleeves.

The above references in all sections of this application are herein incorporated by references in their entirety for all purposes. For purposes of interpreting the claims for the present invention, it is expressly intended that the provisions of Section 112, sixth paragraph of 35 U.S.C. are not to be invoked unless the specific terms “means for” or “step for” are recited in a claim

All of the features disclosed in this specification (including the references incorporated by reference, including any accompanying claims, abstract and drawings), and/or all of the steps of any method or process so disclosed, may be combined in any combination, except combinations where at least some of such features and/or steps are mutually exclusive.

Each feature disclosed in this specification (including references incorporated by reference, any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment (s). The invention extends to any novel one, or any novel combination, of the features disclosed in this specification (including any incorporated by reference references, any accompanying claims, abstract and drawings), or to any novel one, or any novel combination, of the steps of any method or process so disclosed The above references in all sections of this application are herein incorporated by references in their entirety for all purposes.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative aspects. The above described aspects embodiments of the invention are merely descriptive of its principles and are not to be considered limiting. Further modifications of the invention herein disclosed will occur to those skilled in the respective arts and all such modifications are deemed to be within the scope of the invention.

We claim:

1. A potato harvester having a chain conveyor with a plurality of steel cross rods with sequential rods providing a specific first spacing between respective sequential pairs of the cross rods, the plurality of cross rods having a plurality of removable sleeves positioned thereon thereby providing a specific second spacing.

2. The potato harvester of claim 1 wherein each of the cross rods has a central straight portion and has a respective sleeve positioned on the respective straight portion. The potato harvester of claim 1 wherein each of the cross rods has a straight portion positioned between two curved rod portions, the straight portion having a straight portion length and each of the sleeves sized to correspond to the straight portion length.

3. The potato harvester of claim 1 wherein each of the cross rods has a central straight portion and has a respective sleeve positioned on the respective straight portion.

4. The potato harvester of claim 1 wherein each of the cross rods has a plurality of straight portions and each straight portion has a sleeve thereon.

5. The potato harvester of claim 1 wherein each sleeve is inhibited from rotation by at least one of a conforming fit with a respective cross rod, and positioning a slit of each sleeve at a curved portion of each cross bar.

6. The potato harvest or claim 1 wherein each sleeve has a C-shaped cross section with a gap, each sleeve assembled onto each cross rod by way of the gap.

7. The potato harvester of claim 6 wherein each sleeve has a plurality of radially extending ribs.

8. The potato harvester of claim 6 wherein each sleeve is sized to snuggly grip the respective steel cross rod upon which it is placed.

9. The potato harvester of claim 6 wherein each sleeve is formed from extruded polymer.

10. A potato conveying chain with variable spacing, the chain having a length and comprising a pair of rod supporting structures extending the length of the chain and further comprising a plurality of parallel rods extending between the rod supporting structures, the plurality of parallel rods including a series of adjacent pairs of parallel rods with each adjacent pair of the parallel rods having a specific desired common spacing, the chain further comprising a plurality of removable sleeves sized for placement on the plurality of parallel rods.

11. The potato conveying chain of claim 10 wherein the plurality of removable sleeves comprises sleeves of at least two different maximum diameters.

12. The potato conveying chain of claim 10 wherein the plurality of removable sleeves comprises sleeves of at least two different maximum diameters.

13. A method of retrofitting a potato harvester chain conveyor to change the spacing, the chain conveyor comprising a series of parallel cross rods supported by a plurality of endless support portions, the method comprising:
placing on each one or every other one of the cross rods a removable sleeve thereby decreasing spacing between each two consecutive cross rods.

14. The method of claim 13 further comprising pressing and progressively press fitting the sleeve over the rod.

15. The method of claim 13 wherein the placing comprises manually widening the slit to fit over the rod and snapping the sleeve in place.

16. The method of claim 13 further comprising using one of a mallet, a hammer, a pliers, and a channel lock for snapping the sleeve in place.

17. The method of any of claim 13 further comprising cutting each of the sleeves to a desired length.

18. The method of any of claim 13 further comprising non rotatably attaching each sleeve to the respective cross bar.
